(19) United States
(12) Patent Application Publication
(10) Pub. No.: US 2013/0333053 A1
(43) Pub. Date: Dec. 12, 2013

(54) METHOD FOR PROTECTING FIRMWARE BEING UPDATED

(71) Applicants: CHENG-HSIEN CHUNG, TAINAN CITY (TW); HONG-YUE YANG, KAOHSIUNG CITY (TW)

(72) Inventors: CHENG-HSIEN CHUNG, TAINAN CITY (TW); HONG-YUE YANG, KAOHSIUNG CITY (TW)

(73) Assignee: ASKEY COMPUTER CORP.

(21) Appl. No.: 13/558,389

(22) Filed: Jul. 26, 2012

(30) Foreign Application Priority Data
Jun. 7, 2012 (TW) 101120505

(51) Int. Cl. G06F 21/24

(52) U.S. Cl. 726/28

(57) ABSTRACT

A method for protecting firmware being updated is applicable to an electronic device installed with an open operating platform and applicable to a firmware update tool having a preset unlocking password. The method includes an unlocking step and a specific password generating step. In the specific password generating step, the unlocking password is updated according to the difference between product serial number-related information at the point in time of delivery of an electronic device. Although the preset unlocking password in the source code of the firmware update tool is disclosed, nobody other than the electronic product users and the electronic device manufacturers knows the first unlocking password and the second unlocking password. Accordingly, the method provides a security mechanism for the electronic device and the firmware update tool.

### CROSS-REFERENCE TO RELATED APPLICATION

This non-provisional application claims priority under 35 U.S.C. §119(a) on Patent Application No(s). 101120505 filed in Taiwan, R.O.C. on Jun. 7, 2012, the entire contents of which are hereby incorporated by reference.

### FIELD OF TECHNOLOGY

The present invention relates to protection methods, and more particularly, to a method for protecting firmware that is operating on an open operating platform and being updated.

### BACKGROUND

Due to the ever-increasing hardware functions of electronic devices as well as the rapid development of wireless network environments and open operating systems, such as the Android operating system, portable electronic devices nowadays have become indispensable mobile digital assistants to people.

However, in the aforesaid open networking and operation environments, computer hackers are able to intrude into a user's electronic device, using a wide variety of channels, with a view to acquiring the paramount administrator's authority, such as the root authority, in order to steal or tamper with the user's personal data stored in the electronic device.

A firmware update tool for use with an electronic device can be treated by hackers as a channel whereby the hackers intrude into a user's electronic device. The specifications of an open operating platform and program developers' source code are supposed to be disclosed, so is a firmware update tool; hence, hackers can acquire the authority of the paramount administrator who manages an electronic device, by making use of the firmware update tool built in the electronic device on which an open operating platform is installed, so as to access user personal data stored in electronic device to the detriment of the users.

### SUMMARY

It is an objective of the present invention to stop hackers from abusing an open firmware update tool and thereby acquiring the paramount administrator's authority.

In order to achieve the above and other objectives, the present invention provides a method for protecting firmware being updated, the method being applicable to an electronic device having an open operating platform installed thereon and applicable to a firmware update tool having a preset unlocking password, the method comprising the steps of: entering an input password to unlock the firmware update tool based on the input password; and changing the preset unlocking password of the firmware update tool to a first unlocking password and a second unlocking password based on product serial number-related information of the electronic device.

In an embodiment, the step of unlocking the firmware update tool comprises the sub-steps of: a. providing the input password; b. determining whether the firmware update tool has the first unlocking password, going to step (c) when the determination is affirmative, and going to step (d) when the determination is negative; c. determining whether the input password matches the first unlocking password, unlocking the firmware update tool when the determination is affirmative, and going to step (d) when the determination is negative; d. determining whether the firmware update tool has the second unlocking password, going to step (e) when the determination is affirmative, and going to step (f) when the determination is negative; e. determining whether the input password matches the second unlocking password, unlocking the firmware update tool when the determination is affirmative, and outputting a result of the firmware update tool unlocking failure when the determination is negative; and f. determining whether the input password matches the preset unlocking password, unlocking the firmware update tool when the determination is affirmative, and outputting a result of the firmware update tool unlocking failure when the determination is negative.

In an embodiment, the step of updating the preset unlocking password of the firmware update tool comprises the sub-steps of: determining whether the firmware update tool has the first unlocking password, and going to a step below when the determination is negative;

determining whether the firmware update tool has the second unlocking password, and going to a step below when the determination is negative; and generating the first unlocking password and the second unlocking password based on the product serial number-related information of the electronic device.

In an embodiment, the protection method further comprises the steps of: g. receiving the input password; h. determining whether the first unlocking password is present, determining whether the input password matches the first unlocking password when the determination is affirmative, changing the second unlocking password when the determination is affirmative, and going to step (i) when the determination is negative; and i. determining whether the second unlocking password is present, determining whether the input password matches the second unlocking password when the determination is affirmative, changing the second unlocking password when the determination is affirmative, and outputting a result of the second unlocking password changing failure when the determination is negative.

In an embodiment, an encryption mechanism is provided to generation of the first unlocking password and the second unlocking password.

In an embodiment, the open operating platform is the Android operating platform, and the firmware update tool is Fastboot.

Accordingly, although the source code in a firmware update tool has a preset unlocking password and thus is disclosed, an electronic device being delivered updates an unlocking password of the firmware update tool according to product serial number-related information or any other serial number, such that consumers who are not in possession of the electronic device and manufacturers which do not manufacture the electronic device are unaware of the first unlocking password and the second unlocking password, thereby providing a security mechanism for a firmware update tool of the electronic device.

### BRIEF DESCRIPTION OF THE DRAWINGS

Objectives, features, and advantages of the present invention are hereunder illustrated with specific embodiments in conjunction with the accompanying drawings, in which:

FIG. 1 is a flow chart of a method for protecting firmware being updated according to an embodiment of the present invention;

FIG. 2 is a flow chart of the step of changing an unlocking password according to an embodiment of the present invention;

FIG. 3 is a flow chart of an unlocking step according to an embodiment of the present invention; and

FIG. 4 is a flow chart of a specific password generating step according to an embodiment of the present invention.

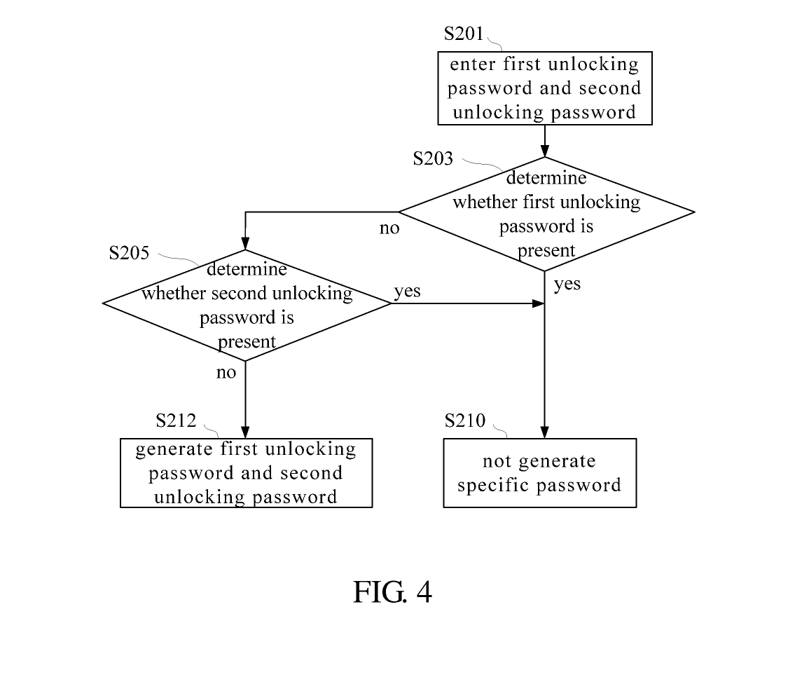

### DETAILED DESCRIPTION

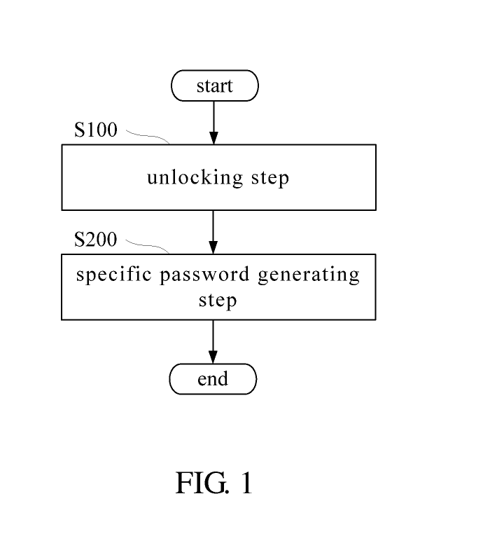

Referring to FIG. 1, there is shown a flow chart of a method for protecting firmware being updated according to an embodiment of the present invention. The method for protecting a firmware update tool according to an embodiment of the present invention is applicable to a firmware update tool for use with an electronic device installed with an open operating platform.

The firmware update tool has a preset unlocking password that serves an unlocking purpose. The preset unlocking password is appended to the source code of the firmware update tool and adapted to create a password unlocking mechanism. The password unlocking mechanism is an antecedent setting for the protection mechanism according to an embodiment of the present invention.

In an embodiment of the present invention, the firmware update tool of an open operating platform is exemplified by the Fastboot of the Android operating platform.

Referring to FIG. 1, the method for protecting a firmware update tool comprises the following steps.

Step S100, which is an unlocking step, involves entering an input password to unlock a firmware update tool, wherein, in case of a first-time operation session, the preset unlocking password will function as the input password to unlock the firmware update tool.

Step S200, which is a specific password generating step, involves changing the preset unlocking password of the firmware update tool to a first unlocking password and a second unlocking password based on product serial number-related information of the electronic device.

The first unlocking password and second unlocking password for a large amount of products are set according to the product serial number-related information, so as to prevent hacks from acquiring an unlocking password easily. The product serial number-related information includes the serial numbers of the same batch of products manufactured and any numbers whereby a large amount of identical products can be distinguished from each other by group.

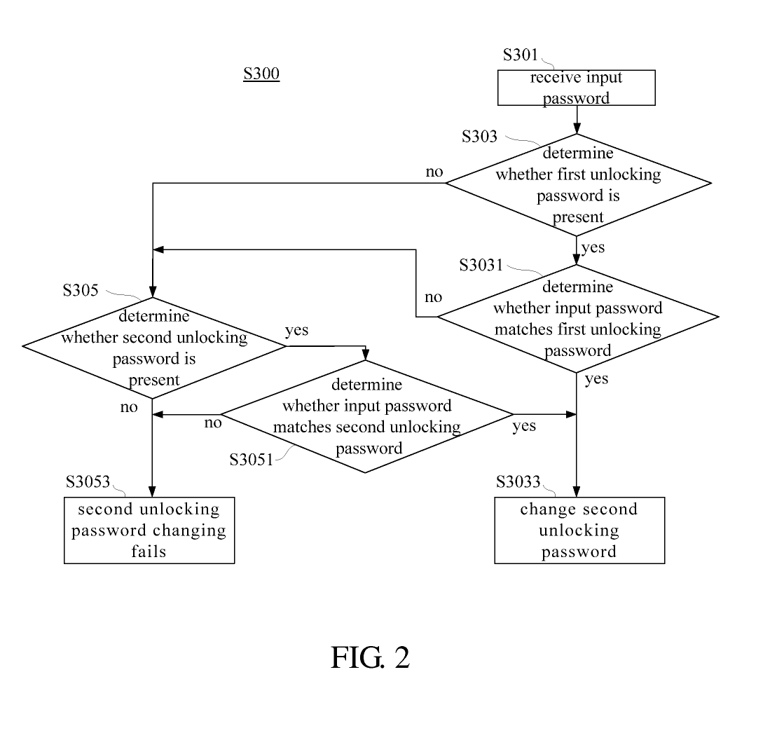

Upon completion of the aforesaid two steps, an unlocking password of a firmware update tool is created. Afterward, referring to FIG. 2, there is shown a flow chart of the step of changing an unlocking password according to an embodiment of the present invention. Preferably, referring to FIG. 2, step S200 of FIG. 1 is followed by step S300, which is a second unlocking password changing step comprising the following sub-steps.

Step S301: receiving the input password. For example, a command for the Fastboot firmware update tool in the Android operating platform is as follows:

Fastboot oem password<input password><newpassword>

Step S303: determining whether the first unlocking password is present, going to step S3031 when the determination is affirmative, and going to step S305 when the determination is negative.
Step S3031: determining whether the input password matches the first unlocking password, going to step S3033 when the determination is affirmative, and going to step S305 when the determination is negative.
Step S3033: changing the second unlocking password.
Step S305: determining whether the second unlocking password is present, going to step S3051 when the determination is affirmative, and going to step S3053 when the determination is negative.
Step S3051: determining whether the input password matches the second unlocking password, going to step S3033 when the determination is affirmative, and going to step S3053 when the determination is negative.
Step S3033: changing the second unlocking password.
Step S3053: outputting a result of the second unlocking password changing failure.

Given the aforesaid command, the step of changing the second unlocking password (step S3033) involves changing the original second unlocking password to “newpassword”.

The second unlocking password changing step (step S300) provides an end user (a consumer who uses the electronic device actually) with a password changing mechanism for enhancing the security of personal data. In a preferred embodiment, the first unlocking password is exclusively kept by a manufacturer, such that the manufacturer can provide an unlocking service to end users whenever the end users forget the changed second unlocking passwords.

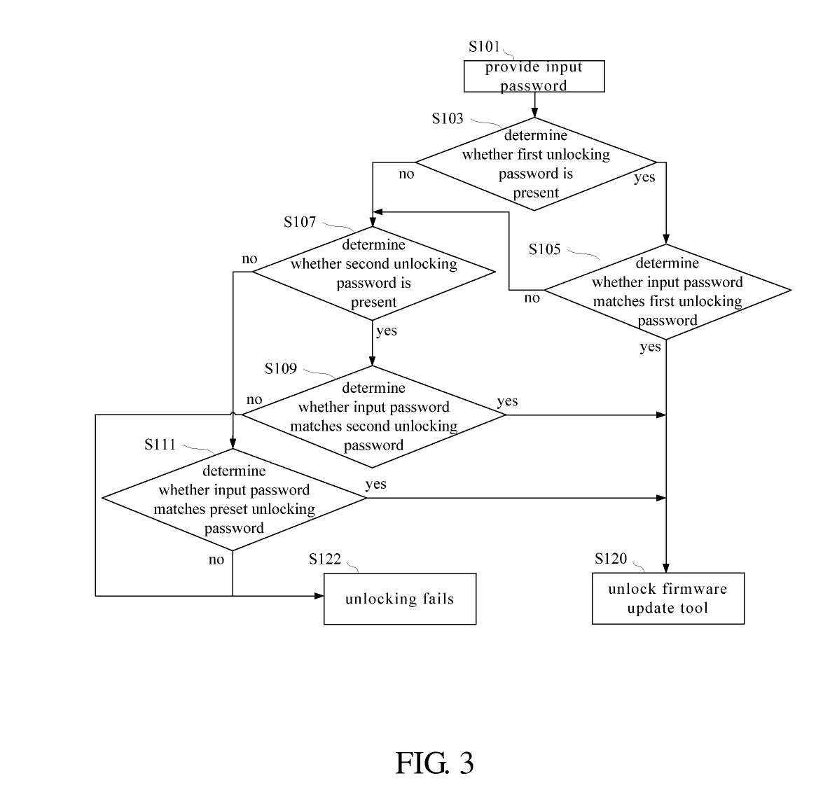

Referring to FIG. 3, the unlocking step (S100) comprises the following sub-steps.

Step S101, which is a password entering step, involves providing the input password. For example, a related command for use with the Fastboot firmware update tool in the Android operating platform is as follows:

### Fastboot oem unlock <input password>

Step S103, which is a first unlocking password detecting step, involves determining whether the firmware update tool has the first unlocking password, going to step S105 when the determination is affirmative, and going to step S109 when the determination is negative.

Step S105, which is a first unlocking password determining step, involves determining whether the input password matches the first unlocking password, going to step S120 when the determination is affirmative, and going to step S107 when the determination is negative.

Step S107, which is a second unlocking password detecting step, involves determining whether the firmware update tool has the second unlocking password, going to step S109 when the determination is affirmative, and going to step S111 when the determination is negative.

Step S109, which is a second unlocking password determining step, involves determining whether the input password matches the second unlocking password, going to step S120 when the determination is affirmative, and going to step S122 when the determination is negative.

Step S111, which the preset unlocking password determining step, involves determining whether the input password matches the preset unlocking password, going to step S120 when the determination is affirmative, and going to step S122 when the determination is negative.

Step S120: unlocking the firmware update tool.

Step S122: outputting a result of the firmware update tool unlocking failure.

The aforesaid unlocking step (S100) reads three passwords. By the time when the manufacturer produces the electronic device, the first unlocking password and the second unlocking password have not yet been generated; hence, the process flow of the aforesaid unlocking step (S100) does not start unlocking the firmware update tool until step (S111) and step (S120) begin, so as to operate the firmware update tool and write thereto the specific unlocking password.

Referring to FIG. 3, in an embodiment, the specific password generating step (S200) comprises the following sub-steps.

Step S201: entering the first unlocking password <supasswd> and the second unlocking password <userpasswd>. For example, a command for the Fastboot firmware update tool in the Android operating platform is as follows:

Fastboot oem generatepassword <supasswd><userpasswd>

Step S203: determining whether the firmware update tool has the first unlocking password, going to step S210 when the determination is affirmative, and going to step S205 when the determination is negative.

Step S205: determining whether the firmware update tool has the second unlocking password, going to step S210 when the determination is affirmative, and going to step S212 when the determination is negative.

Step S210: not generating a specific password.

Step S212: generating the first unlocking password <supasswd> and generating the second unlocking password <userpasswd> based on product serial number-related information of the electronic device.

Furthermore, to enhance the aforesaid protection, the process of generation of the first unlocking password and the second unlocking password is rendered secure by means of an encryption mechanism. For example, adding a generated password and an ID number of an electronic component of the electronic device, and scrambling the summative code. Preferably, the electronic component for use with the encryption mechanism is a central processing unit (CPU), and identifier is CPU ID. The identifier is associated with another identifier unique to hardware so as to further enhance password security.

In conclusion, a security mechanism for a firmware update tool is enhanced greatly by means of three passwords and a mechanism which cannot be activated unless and until the firmware update tool is unlocked. This, coupled with the association of a password and a hardware identifier, further enhances password security and prevents a hacker from intruding into an electronic device installed with an open operating platform.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A method for protecting firmware being updated, the method being applicable to an electronic device having an open operating platform installed thereon and applicable to a firmware update tool having a preset unlocking password, the method comprising the steps of:
entering an input password to unlock the firmware update tool based on the input password; and
changing the preset unlocking password of the firmware update tool to a first unlocking password and a second unlocking password based on product serial number-related information of the electronic device.

2. The method of claim 1, wherein the step of unlocking the firmware update tool comprises the sub-steps of:
a. providing the input password;
b. determining whether the firmware update tool has the first unlocking password, going to step (c) when the determination is affirmative, and going to step (d) when the determination is negative;
c. determining whether the input password matches the first unlocking password, unlocking the firmware update tool when the determination is affirmative, and going to step (d) when the determination is negative;
d. determining whether the firmware update tool has the second unlocking password, going to step (e) when the determination is affirmative, and going to step (f) when the determination is negative;
e. determining whether the input password matches the second unlocking password, unlocking the firmware update tool when the determination is affirmative, and outputting a result of the firmware update tool unlocking failure when the determination is negative; and
f. determining whether the input password matches the preset unlocking password, unlocking the firmware update tool when the determination is affirmative, and outputting a result of the firmware update tool unlocking failure when the determination is negative.

3. The method of claim 1, wherein the step of updating the preset unlocking password of the firmware update tool comprises the sub-steps of:
determining whether the firmware update tool has the first unlocking password, and going to a step below when the determination is negative;
determining whether the firmware update tool has the second unlocking password, and going to a step below when the determination is negative; and
generating the first unlocking password and the second unlocking password based on the product serial number-related information of the electronic device.

4. The method of claim 1, further comprising the steps of:
g. receiving the input password;
h. determining whether the first unlocking password is present, determining whether the input password matches the first unlocking password when the determination is affirmative, changing the second unlocking password when the determination is affirmative, and going to step (i) when the determination is negative; and
i. determining whether the second unlocking password is present, determining whether the input password matches the second unlocking password when the determination is affirmative, changing the second unlocking password when the determination is affirmative, and outputting a result of the second unlocking password changing failure when the determination is negative.

5. The method of claim 1, wherein an encryption mechanism is provided to generation of the first unlocking password and the second unlocking password.

6. The method of claim 1, wherein the open operating platform is Android operating platform, and the firmware update tool is Fastboot.
